(19) United States
(12) Patent Application Publication
(10) Pub. No.: US 2020/0090102 A1
(43) Pub. Date: Mar. 19, 2020

(54) SYSTEM AND METHOD FOR GENERATING DASHBOARDS

(71) Applicant: ACTIO Analytics Inc., Tampa, FL (US)

(72) Inventors: Kevin MacNeill, Ottawa Ontario (CA); John S. Simon, JR., Marietta, GA (US)

(21) Appl. No.: 16/573,145

(22) Filed: Sep. 17, 2019

Related U.S. Application Data
(60) Provisional application No. 62/732,351, filed on Sep. 17, 2018.
(60) Provisional application No. 62/732,381, filed on Sep. 17, 2018.

(51) Int. Cl. G06Q 10/06; G06Q 20/20

(52) U.S. Cl. CPC G06Q 10/06393; G06Q 20/202; G06Q 20/206

(57) ABSTRACT

A method, computer program product, and computer system for preloading, on a first computing device, data associated with a client. An authorization process is executed, via the first computing device, between the first computing device and the second computing device. A first dashboard is generated on the second computing device. The first dashboard including the data associated with the client.

### CROSS-REFERENCE TO RELATED APPLICATIONS

This application claims the benefit of U.S. Provisional Application No. 62/732,351, filed on 17 Sep. 2018, and U.S. Provisional Application No. 62/732,381, filed on 17 Sep. 2018, the contents of both of which are incorporated by reference.

### BACKGROUND

Business intelligence and analytics continues to be a fast-growing area of interest. Current solutions are complex because they include multiple entities, data sets, different software applications, differences in processing cycles, added customization, and the need for professional services.

Attaining a large customer base for business intelligence and analytics requires a multi-step process involving several players authorizing shared accounting and data provisioning. Even more, retrieving authorization and facilitating data flow between several players requires a considerable amount of time to execute as well as to organize the many sources of data into the most accurate and relevant form. While data analytics offer customers a diagnostic framework to effect business decisions, the results of such analytics may not accurately reflect data in real-time or effectively display the data in a format that would prove most useful toward determining overall business performance for an individual customer.

### BRIEF SUMMARY OF DISCLOSURE

In one example implementation, a method, performed by one or more computing devices, may include but is not limited to preloading, on a first computing device, data associated with a client. An authorization process may be executed, via the first computing device, between the first computing device and a second computing device. A first dashboard may be generated on the second computing device. The first dashboard may include the data associated with the client.

One or more of the following example features may be included. The method may further include establishing a connection between the second computing device and a communication enabler. Data associated with the client may include, at least in part, point-of-sale data. Preloading the data associated with the client may include generating a sample dashboard. The sample dashboard may include at least a portion of the data associated with the client. Executing the authorization process between the first computing device and the second computing device may include generating an invitation, via an authorization window, on the first computing device. Executing the authorization process between the first computing device and the second computing device may further include sending the invitation from the first computing device to the second computing device. Executing the authorization process between the first computing device and the second computing device may further include verifying, at the second computing device, the data associated with the client.

In another example implementation, a computer program product may reside on a non-transitory computer readable storage medium having a plurality of instructions stored thereon which, when executed across one or more processors, may cause at least a portion of the one or more processors to perform operations that may include but are not limited to preloading, on a first computing device, data associated with a client. An authorization process may be executed, via the first computing device, between the first computing device and a second computing device. A first dashboard may be generated on the second computing device. The first dashboard may include the data associated with the client.

One or more of the following example features may be included. The method may further include establishing a connection between the second computing device and a communication enabler. Data associated with the client may include, at least in part, point-of-sale data. Preloading the data associated with the client may include generating a sample dashboard. The sample dashboard may include at least a portion of the data associated with the client. Executing the authorization process between the first computing device and the second computing device may include generating an invitation, via an authorization window, on the first computing device. Executing the authorization process between the first computing device and the second computing device may further include sending the invitation from the first computing device to the second computing device. Executing the authorization process between the first computing device and the second computing device may further include verifying, at the second computing device, the data associated with the client.

In another example implementation a computing system may include one or more processors and one or more memories configured to perform operations that may include but are not limited to preloading, on a first computing device, data associated with a client. An authorization process may be executed, via the first computing device, between the first computing device and a second computing device. A connection may be established between the second computing device and a communication enabler. A first dashboard may be generated on the second computing device. The first dashboard may include the data associated with the client.

One or more of the following example features may be included. Data associated with the client may include, at least in part, point-of-sale data. Preloading the data associated with the client may include generating a sample dashboard. The sample dashboard may include at least a portion of the data associated with the client. Executing the authorization process between the first computing device and the second computing device may include generating an invitation, via an authorization window, on the first computing device. Executing the authorization process between the first computing device and the second computing device may further include sending the invitation from the first computing device to the second computing device. Executing the authorization process between the first computing device and the second computing device may further include verifying, at the second computing device, the data associated with the client.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a dashboard generation process coupled to an example distributed computing network according to one or more example implementations of the disclosure;

FIG. 2 is an example flowchart of a dashboard generation process according to one or more example implementations of the disclosure;

FIG. 3 is an example diagrammatic view of dashboard generation process according to one or more example implementations of the disclosure;

FIG. 4 is an example diagrammatic view of various point-of-sale systems according to one or more example implementations of the disclosure;

FIG. 5 is an example flowchart of a dashboard generation process according to one or more example implementations of the disclosure;

FIG. 6 is an example dashboard of a dashboard generation process according to one or more example implementations of the disclosure;

FIG. 7 is an example flowchart of a dashboard generation process according to one or more example implementations of the disclosure;

FIG. 8 is a graphical illustration of analytical data according to one or more example implementations of the disclosure; and

FIG. 9 is an example diagrammatic view of a computer of FIG. 1 according to one or more example implementations of the disclosure;

Like reference symbols in the various drawings indicate like elements.

### DETAILED DESCRIPTION

### System Overview:

Attaining a large customer base for business intelligence and analytics requires a multi-step process involving several players authorizing shared accounting and data provisioning. Even more, retrieving authorization and facilitating data flow between several players requires a considerable amount of time to execute as well as to organize the many sources of data into the most accurate and relevant form. While data analytics offer customers a diagnostic framework to effect business decisions, the results of such analytics may not accurately reflect data in real-time or effectively display the data in a format that would prove most useful toward determining overall business performance. Accordingly, in some implementations, the present disclosure may provide one or more clients with an immediate ability to access powerful analytic insights and sophisticated business analysis to effectuate growth of sales and margins. Additionally, the accrual of a large data base with a wide variety of data elements provides a multitude of dashboard options that may be customized where appropriate for different kinds of clients. Consistent with this approach, an operator of a dashboard generating process may “drill-down” or aggregate point-of-sale data (e.g., across different dimensions of location, product, date and time, staff, marketing programs, weather, and other potential causal data) associated with the one or more clients at on and/or off-premise locations and may deliver proprietary analytics via real-time mobile dashboards for the one or more clients, one or more reports that allow a client to drill down into on premise transaction sales, and insights that identify cause and effect relationships relative to overall business performance.

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

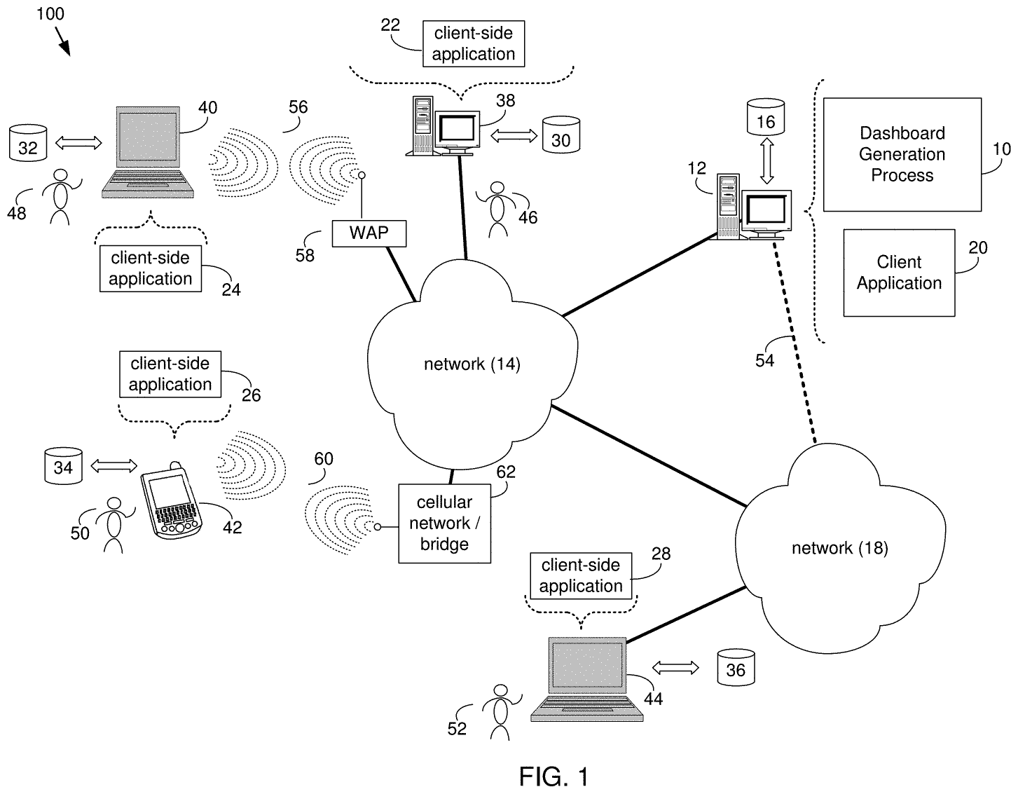

Referring now to the example implementation of FIG. 1, there is shown dashboard generation process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a RAID device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a dashboard generation process, such as dashboard generation process 10 of FIG. 1, may include preloading, on a first computing device, data associated with a client. An authorization process may be executed, via the first computing device, between the first computing device and a second computing device. A first dashboard may be generated on the second computing device. The first dashboard may include the data associated with the client.

In some implementations, as will be discussed below in greater detail, a dashboard generation process, such as dashboard generation process 10 of FIG. 1, may include generating a dashboard based upon data associated with a client. The data associated with the client may be analyzed. A recommendation to modify the dashboard may be provided. A new version of the dashboard may be generated.

In some implementations, the instruction sets and subroutines of dashboard generation process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network; or an intranet, for example.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, dashboard generation process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a client application (e.g., client application 20), examples of which may include, but are not limited to, e.g., point-of-sale applications/systems, performance reporting applications/systems, inventory applications/systems, delivery applications/systems, analytics applications/systems, ordering applications/systems, etc. In some implementations, dashboard generation process 10 and/or client application 20 may be accessed via one or more of client-side applications 22, 24, 26, 28. In some implementations, dashboard generation process 10 may be a standalone application, or may be an applet/application/script/extension that may interact with and/or be executed within client application 20, a component of client application 20, and/or one or more of client-side applications 22, 24, 26, 28. In some implementations, client application 20 may be a standalone application, or may be an applet/application/script/extension that may interact with and/or be executed within dashboard generation process 10, a component of dashboard generation process 10, and/or one or more of client-side applications 22, 24, 26, 28. In some implementations, one or more of client-side applications 22, 24, 26, 28 may be a standalone application, or may be an applet/application/script/extension that may interact with and/or be executed within and/or be a component of dashboard generation process 10 and/or client application 20. Examples of client-side applications 22, 24, 26, 28 may include, but are not limited to, e.g., point-of-sale applications (e.g., executed by a point-of-sale terminal), performance reporting applications/systems, inventory applications/systems, delivery applications/systems, analytics applications/systems, ordering applications/systems, a standard and/or mobile web browser, an email application (e.g., an email client application), a textual and/or a graphical user interface, a customized web browser, a plugin, an Application Programming Interface (API), or a custom application. The instruction sets and subroutines of client-side applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a point-of-sale terminal (e.g., computing device used to process and record transactions), a server, a television, a smart television, a media (e.g., video, photo, etc.) capturing device, and a dedicated network device. In some implementations, each of client electronic devices 38, 40, 42, 44 may each execute a point-of-sale application/system for recording transactions. Accordingly and in some implementations, client devices 38, 40, 42, 44 may be considered point-of-sale terminals. Client electronic devices 38, 40, 42, 44 may each execute an operating system, examples of which may include but are not limited to, Android™ Apple® iOS®, Mac® OS X®; Red Hat® Linux®, Windows® Mobile, Chrome OS, Blackberry OS, Fire OS, or a custom operating system.

In some implementations, one or more of client-side applications 22, 24, 26, 28 may be configured to effectuate some or all of the functionality of dashboard generation process 10 (and vice versa). Accordingly, in some implementations, dashboard generation process 10 may be a purely server-side application, a purely client-side application, or a hybrid server-side/client-side application that is cooperatively executed by one or more of client-side applications 22, 24, 26, 28 and/or dashboard generation process 10.

In some implementations, one or more of client-side applications 22, 24, 26, 28 may be configured to effectuate some or all of the functionality of client application 20 (and vice versa). Accordingly, in some implementations, client application 20 may be a purely server-side application, a purely client-side application, or a hybrid server-side/client-side application that is cooperatively executed by one or more of client-side applications 22, 24, 26, 28 and/or client application 20. As one or more of client-side applications 22, 24, 26, 28, dashboard generation process 10, and client application 20, taken singly or in any combination, may effectuate some or all of the same functionality, any description of effectuating such functionality via one or more of client-side applications 22, 24, 26, 28, dashboard generation process 10, client application 20, or combination thereof, and any described interaction(s) between one or more of client-side applications 22, 24, 26, 28, dashboard generation process 10, client application 20, or combination thereof to effectuate such functionality, should be taken as an example only and not to limit the scope of the disclosure.

In some implementations, one or more of users 46, 48, 50, 52 may access computer 12 and dashboard generation process 10 (e.g., using one or more of client electronic devices 38, 40, 42, 44) directly through network 14 or through secondary network 18. Further, computer 12 may be connected to network 14 through secondary network 18, as illustrated with phantom link line 54. Dashboard generation process 10 may include one or more user interfaces, such as browsers and textual or graphical user interfaces, through which users 46, 48, 50, 52 may access dashboard generation process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client-side applications 22, 24, 26, 28 to, e.g., computer 12. Examples of I/O request 15 may include but are not limited to, data write requests (e.g., a request that content be written to computer 12) and data read requests (e.g., a request that content be read from computer 12).

### The Dashboard Generation Process:

As discussed above and in some implementations, business intelligence and analytics continues to be a fast-growing area of interest. Clients in the service industry, including but not limited to the restaurant industry (e.g., eating and drinking business units/business units that purchase and/or sell food and/or drink for on and/or off-premise consumption), due to its unique business model, are often not able to take advantage of current real time business intelligence and analytics solutions. Current solutions are complex because they include multiple data sets, different software applications, added customization, and the need for professional services.

Attaining a large customer base for business intelligence and analytics requires a multi-step process involving several players authorizing particular accounting and data provisioning. Even more, retrieving authorization and facilitating the data flow between the several players requires a considerable amount of time to execute, as well as to organize the many sources of data into an accurate and relevant form.

While data analytics offer customers a diagnostic framework to affect business decisions, the results of such analytics may not accurately reflect data in real-time or effectively display the data in a format that would prove most useful toward determining overall business performance.

Recognizing that new clients may need to be implemented (e.g., by the thousands) quickly and efficiently, a need exists for facilitating a more efficient implementation process for rapid roll-out of authorizing real time business-intelligence services and analytics solutions, and initiating an onboarding process in a manner which minimizes overall costs and elapsed time by using sales representatives, agents, and various channel partners.

As will be discussed in greater detail below, embodiments of the present disclosure may provide a system and method of allowing channel partners and clients to execute an authorization process, via a computing device, to facilitate a data flow and generate a variety of dashboards based upon the particular business-intelligence service and analytics solution implemented against the client data. In some implementations of the present disclosure, it may be observed that clients are more quickly linked to an analytical provider and, as such, point-of-sale data is more quickly provided to the analytics provider and analytical solutions may be provided to the client with fewer interactions between the client and the analytics provider.

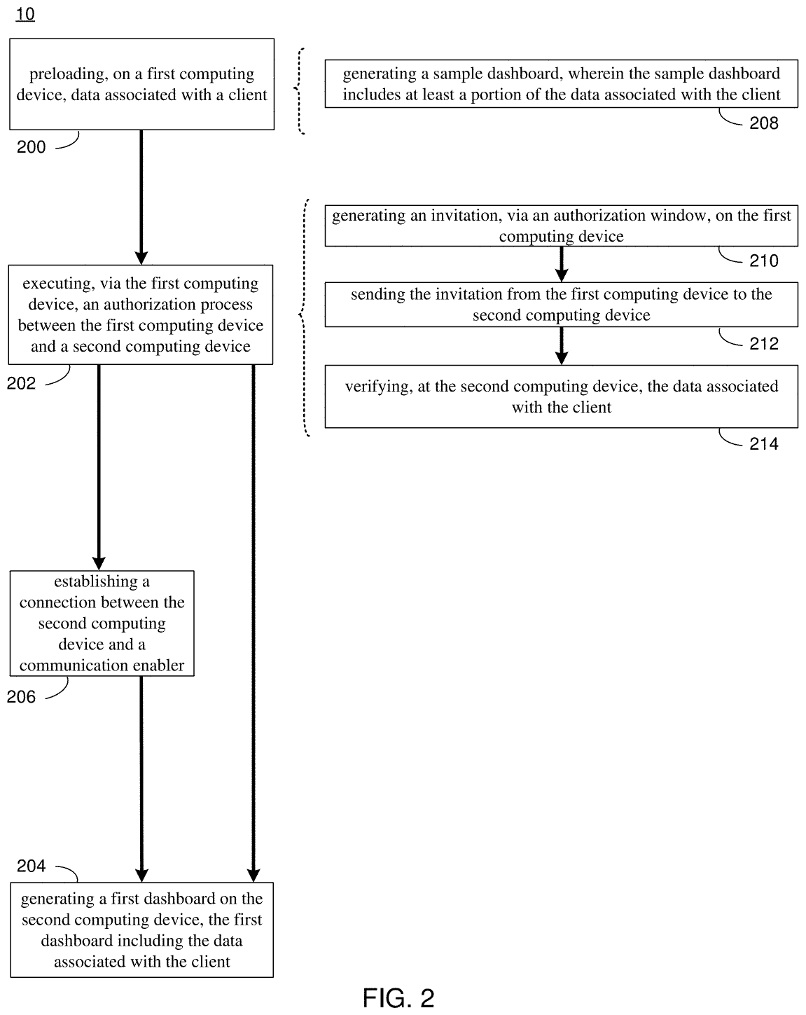

As will be discussed in greater detail, and referring also at least to the example implementation of FIG. 2, dashboard generation process 10 may preload 200, on a first computing device, data associated with a client. An authorization process may be executed 202, via the first computing device, between the first computing device and a second computing device. A first dashboard may be generated 204 on the second computing device, wherein the first dashboard may include the data associated with the client.

In some implementations, dashboard generation process 10 may preload 200, on a first computing device, data associated with a client. For example, a “client” may generally include an entity or establishment regarded as single and complete, but which can also form an individual component of a larger or more complex whole, and may identify as extended retail (e.g., entities which sell finished goods, including prepared food and/or beverages, for on and/or off-premise use and/or consumption, of which may include a service provider in the service industry (e.g., food and beverage companies and/or bottlers and/or distributors of food, beverages, and suppliers of other product packaging of the like), their customers (e.g., restaurant, franchise, chain, or restaurant-bar, retailer, etc.), and third parties (e.g., market research firms, real estate investors, financial analysts, etc.)), entertainment and hospitality industries (e.g., stadiums, entertainment venues, casinos, hotels, motels, etc.) including their suppliers of raw materials, prepared component parts for transformation into finished products, finished goods, and entertainment services for on and/or off premise consumption, resale, supplies and sundries and the associated, related transportation, information, and financial services supporting that supply chain. It will be appreciated that while several examples referencing food and beverage industry type clients have been provided, these are for example purposes only and any type of client can be imagined within the scope of the present disclosure.

As will be discussed in greater detail, the data associated with the client may include, at least in part, prospect data. For example, prospect data associated with the client may include, e.g., location information, franchise information, type of business, point of contact, etc. In some implementations, the prospect data associated with the client may include, at least in part, point-of-sale data. For example, point-of-sale data may include, but is not limited to, information such as a date of a transaction, the location of the transaction, the time of the transaction, a register, (and if applicable) cashier or server, the product(s) and/or service(s) involved in the transaction, a quantity of product(s) and/or service(s), the price of the product and/or services, any applicable discounts including but not limited to standard volume discounts, marketing promotions, coupons, and employee discounts, a subtotal, applicable taxes, a method of payment, credit or debit card numbers, a customer loyalty number, warranty information, contact information, and some form of marketing including, but not limited to, a customer survey, a coupon for future use, information on promotion, etc.

For example and in some implementations, preloading 200 data associated with a client may include importing and maintaining prospect data in an internal provider database of an analytics provider. Prospect data may be sourced from, but is not limited to, sponsors and channels, brands and cross-brands, third party relationships, customers with entity, customer numbers, logos, locations, known employees, point-of-sale data, public sources, product tables, demo data, customers sharing a similar provider, and other systems of the like.

It will be appreciated that a “brand” may generally include a type of product manufactured by, or service provided by, a particular company under a particular name, and “cross-brand” may generally include a similar type of product manufactured, or service provided, by another company under a different name.

In some implementations, preloading 200 data associated with a client may include standardizing the prospect data into an analytics provider specific customer data format. For example, standardizing the prospect data into an analytics provider specific customer data format may include normalizing (i.e., transforming and/or cleansing) the prospect data into a provider account and attaining a prospect status. For example, normalizing the prospect data into a provider account includes assigning one or more sponsors, a channel price, and billing term to the analytics provider account.

Continuing with this example, it will be appreciated that upon assigning the client to the one or more sponsors, the one or more sponsors may access the prospect data on the analytics provider account and amend the information on the provider account relative to the relative to the prospect data (e.g., list what type of restaurant it is, etc.) and can see if any other clients, to which they are also assigned to, are also enabled on the analytics provider account.

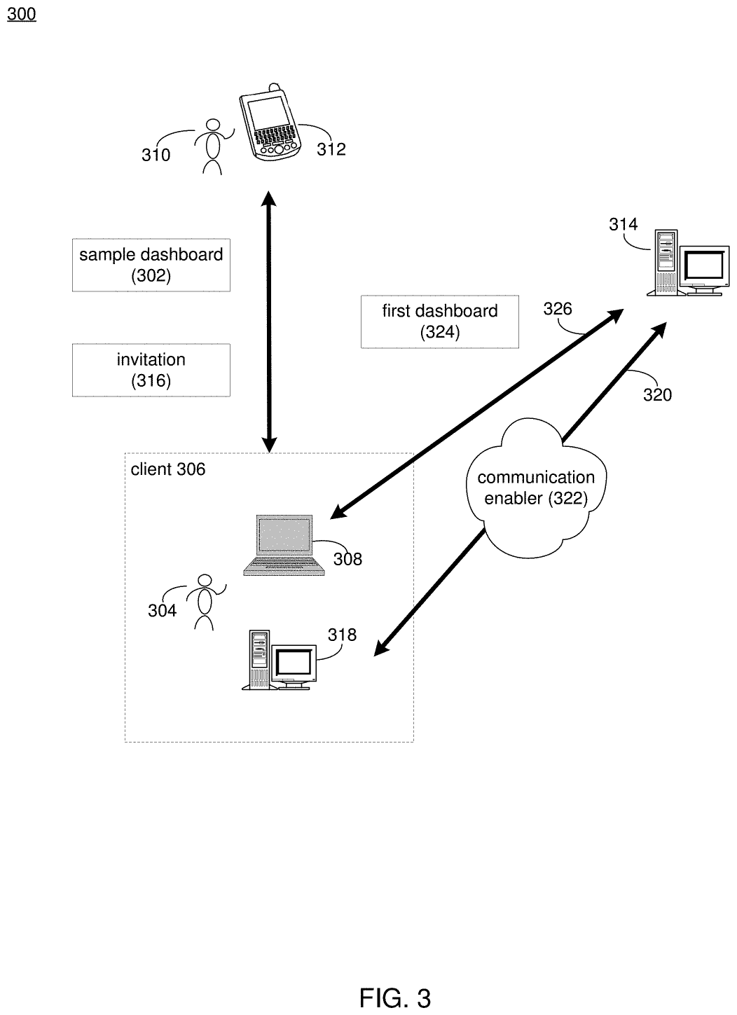

In some implementations, preloading 200 the data associated with the client may include generating 208 a sample dashboard, wherein the sample dashboard may include at least a portion of the data associated with the client. A dashboard may generally include a software module with one or more user interface portions for displaying analytical data generated from point-of-sale data received from the client. For example and referring also to the example of FIG. 3, a sample dashboard (e.g., sample dashboard 302) may be demonstrative such that the sample dashboard may enable a sales representative to demonstrate to a client how to initiate a new account on an analytics provider database. For example, if the client is a franchisee, the sample dashboard (e.g., sample dashboard 302) may be generated with analytical data from other franchisees selling similar food and beverage products. In some implementations, analytical data from other, similar clients may be used to generate the sample dashboard but with the data aggregated to avoid identifying specific other clients individually.

In some implementations, dashboard generation process 10 may execute 202, via the first computing device, an authorization process between the first computing device and a second computing device. As will be discussed in greater detail, executing 202 an authorization process between the first computing device and the second computing device may include generating 210 an invitation, via an authorization window, on the first communication device. For example and referring again to the example of FIG. 3, suppose user 304 represents a client (e.g., client 306) and that user 304 is operating a computing device (e.g., second computing device 308). In this example, user 310 may represent an analytics provider and may operate a computing device (e.g., first computing device 312). In some implementations, the first computing device (e.g., first computing device 312) may be a portion of an analytical provider database (e.g., analytical provider database 314). In other words, the first computing device may collect point-of-sale data and generate analytics on the point-of-sale data for specific clients. In another example, the first computing device (e.g., first computing device 312) may be separate from the analytics provider database (e.g., analytics provider database 314). For example, first computing device 312 may be a computing device associated with an agent or representative of the analytics provider. In this example, user 310 of first computing device 312 may preload 200 data associated with the client and execute (via dashboard generation process 10) an authorization process with second computing device 307. In this manner, agents or sales representatives of an analytics provider may execute an authorization process with a client (e.g., client 306 via user 304 via computing device 308) independent of the analytics provider database (e.g., analytics provider database 12). While an agent or sales representative has been discussed as an example of a user of a first computing device separate from the analytics provider database, it will be appreciated that other roles or users are possible within the scope of the present disclosure.

As discussed above, data associated with the client may be preloaded 200. For example, dashboard generation process 10 may preload data associated with client 306's food and beverage business including e.g., location, franchise, brand, similar restaurants, local competitors, menu information, contact information, etc.). As will be discussed in greater detail below, dashboard generation process 10 may execute, via first computing device 312 an authorization process between the first computing device and second computing device 308. For example, suppose user 310 provided, via computing device 312, user 304 with information regarding the services of an analytics provider. Instead of the conventional process of leaving the client to enroll in the services of an analytics provider, dashboard generation process 10 may provide an authorization process to enable the client (e.g., client 306 via user 304 and computing device 308) to quickly enroll in the services of an analytics provider based upon, at least in part, the preloaded data associated with the client.

In some implementations, executing 202 the authorization process between the first communication device and the second communication device may include generating 210 an invitation, via an authorization window, on the first communication device. In some implementations, the invitation (e.g., invitation 316) may include an invitation code. For example, in some implementations, the code included in the invitation may be randomly generated by dashboard generation process 10.

In some implementations, executing 202 the authorization process between the first communication device and the second communication device may include sending 212 the invitation from the first communication device to the second communication device. For example, sending 212 the invitation (e.g., invitation 316) from the first communication device to the second communication device may include sending the invitation (e.g., invitation 316) from the first communication device to the second communication device via a specialized communication. In some implementations, a specialized communication may include an instant message, an email, or a text message. For example, in some implementations, the authorization window may be displayed in at in at least a portion of a display area of the first computing device (e.g., first computing device 312). For example, in some implementations, the display area of the first computing device (e.g., first computing device 312) may include a graphic user interface (GUI).

In some implementations, executing 202 the authorization process between the first communication device and a second communication device may include verifying 214, at the second computing device, the data associated with the client. Suppose, for example purposes only, that the authorization window may include a click connect approval process. The click connect process may include at least a first button located on a first computing device (e.g., first computing device 312), and a second button located on a second computing device (e.g., second computing device 308). In some implementations, the click connect process may enable a first user (e.g., user 310) to verify, by clicking the first button on the first communication device (e.g., first computing device 312), data (e.g., a location) associated with a second user (e.g., client, target entity). The click connect process may also enable the second user to verify the same data, by clicking a second button on the second communication device (e.g., second computing device 308). For example and as will be discussed in greater detail below, upon verifying the data at both the first computing device and the second computing device, the authorization process may establish a link (i.e., network connection) between the second communication device and a communication enabler (e.g., API Provider, POS Company).

Continuing with the above example, suppose that dashboard generation process 10 may execute 202, an authorization process via a sales representative, e.g., sponsor, agent, etc. After relaying a sales presentation (i.e., in person, via web, or otherwise) about the analytics provider services, showing the client sample dashboard views using demo data similar in nature to the client's business and/or establishment (e.g., sample dashboard 302), and receiving positive affirmation from the client conveying his or her interest in utilizing the analytics provider services, the sales representative may, by clicking a first button on his or her computing device (e.g., first computing device 312), initiate an authorization process.

In some implementations, dashboard generation process 10 may further establish 206 a connection between the second computing device and a communication enabler. In some implementations, a “communication enabler” may generally include an Application Programming Interface (API) provider, e.g., point of sale (POS) company that facilitates data between a point-of-sale system and an analytic provider server. For example, communication enabler 318 may facilitate data flow of the data associated with the client between a point-of-sale system (e.g., point-of-sale system 318) and an analytics provider server (e.g., analytics provider server 314). In some embodiments, establishing the connection between the communication enabler and the second computing device may include providing the communication enabler to the second computing device for installation on one or more of the second computing device and/or a point-of-sale system associated with the client. In some embodiments, the second computing device (e.g., second computing device 308) may include a point-of-sale system. A point-of-sale (POS) system may generally include an order input and transaction log for purchasing product(s) and/or service(s) from a unit. In some implementations, a POS system may include a system for recording online sales (e.g., using the Internet), telephonic sales, automated sales, sales at a retail establishment, a restaurant, etc. As such, and in some implementations, it will be appreciated that a POS system may broadly refer to any transaction recording system regardless of the modality of purchasing products and/or services.

In some implementations, the second computing device (e.g., second computing device 308) may be separate from the point-of-sale system associated with a client (e.g., point-of-sale system 318). For example, suppose that a user utilizes a, e.g., mobile communication device (e.g., second computing device 308) to execute the authorization process with first computing device 312. In this example and as will be discussed in greater detail below, execution of the authorization process via the second communication device (e.g., second computing device 308) may facilitate a flow of point-of-sale data from the separate point-of-sale system (e.g., point-of-sale system 318) and an analytics provider database (e.g., analytics provider database 314).

In some implementations and in response to execution of the authorization process between the first computing device (e.g., first computing device 312) and the second computing device (e.g., second computing device 308), dashboard generation process 10 may establish a connection (e.g., connection 320) between the second computing device (e.g., second computing device 308) and/or a separate point-of-sale system associated with the client (e.g., point of sale system 318) and the communication enabler (e.g., communication enabler 322).

In some implementations, dashboard generation process 10 may generate 204 a first dashboard on the second computing device, wherein the first dashboard may include the data associated with the client. As discussed above, a dashboard may generally include a software module with one or more user interface portions for displaying analytical data generated from point-of-sale data received from the client. As will be discussed in greater detail, in response to authorizing the data flow between an API provider and client network, a first dashboard (e.g., first dashboard 324) may be generated on the second computing device. In some implementations, the first dashboard may be customized based upon the data associated with the client.

In some implementations, generating 204 the first dashboard may include receiving, at the second communication device, a notification indicating that the first dashboard has been generated. For example, the notification may provide a link or other instructions to allow a client to access the first dashboard (e.g., first dashboard 324). For example, analytics provider server 314 may provide a link to or a copy of first dashboard 324 via a connection (e.g., connection 326).

In some embodiments, the first dashboard (e.g., first dashboard 324) may be relatively uncluttered and may contain information relative to a sponsor. However, it will be appreciated that various dashboards may be generated containing data relevant to more than one sponsor depending upon the range of respective products or services (e.g., food and beverage products) provided by the client. In some embodiments, e.g., in which a relatively large range of food and beverage products may be offered for sale at the client's establishment, a more extensive dashboard may be generated, containing data relevant to more than one sponsor.

In some implementations, generating 204 the first dashboard may include recognizing, via artificial intelligence, at least one of known and similar point-of-sale data, and other system data (e.g., prospect data, etc.). In some implementations, the authorization process may recognize, via an artificial intelligence engine (e.g., a machine learning process), known point-of-sales data associated with a client from a plurality of point-of-sales data obtained by an analytics provider. As will be discussed in greater detail below, this recognized point-of-sale data may be processed to generate analytical data for the client. In some implementations, dashboard generation process 10 may generate a test sequence of analytical data associated with the client based upon, at least in part, the point-of-sale data recognized by dashboard generation process 10. Dashboard generation process 10 may generate the first dashboard with an initial dashboard configuration or view with this test sequence of analytical data from the point-of-sale data recognized by dashboard generation process 10.

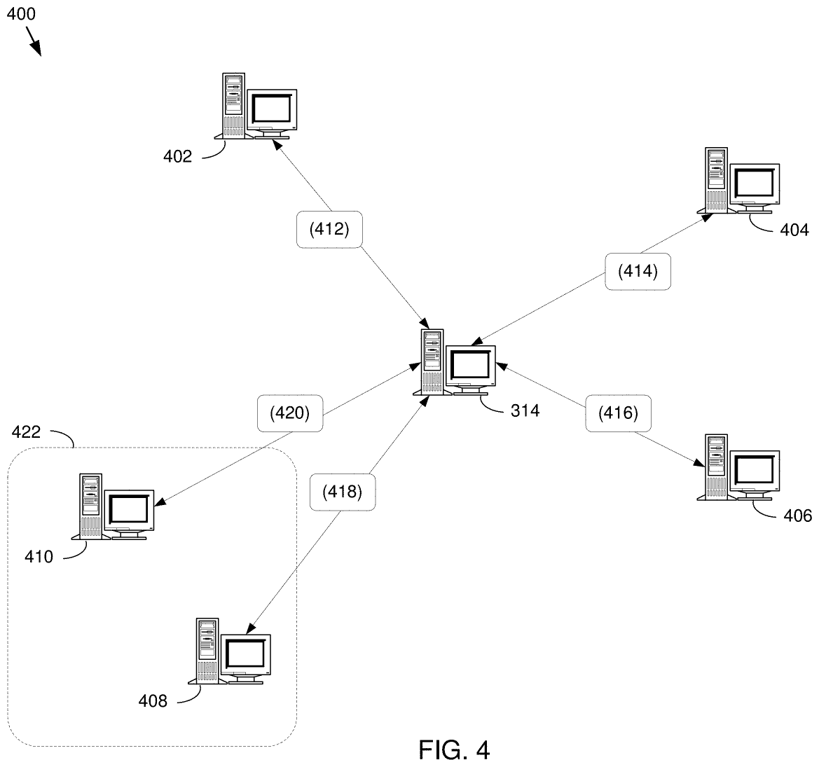

In some embodiments, dashboard generation process 10 may allow point-of-sale data associated with client 306 from point-of-sale system 318 to be processed by analytics provider database 314. In some implementations, dashboard generation process 10 may receive point-of-sale data from point-of-sale system 318 via connection 320. In this example, point-of-sale data from point-of-sale system 318 may be unique from other point-of-sale systems. For example and in some implementations, various units (e.g., businesses, individuals, etc.) may use distinct or unique point-of-sale systems to manage transaction data. In some implementations and as will be discussed in greater detail below, distinct point-of-sale systems may include distinct formats, taxonomies, descriptions, etc. for various products or services. Referring also to the example of FIG. 4 and in some implementations, a plurality of POS systems (e.g., POS systems 402, 404, 406, 408, 410) may record transactions associated with a particular unit (e.g., an eating and drinking business, a hotel, a hospital, etc.) and may generate transaction data associated with each POS system (e.g., transaction data 412, 414, 416, 418, 420). In some implementations, the transaction data associated with each POS system (e.g., transaction data 412, 414, 416, 418, 420) may be stored in the POS system (e.g., POS systems 402, 404, 406, 408, 410) and/or may be stored in one or more databases. For example and in some implementations, transaction data may be generated by a POS system and moved to a database for storage. As such, it will be appreciated that transaction data may be stored in the POS system and/or in a separate database. In some implementations, multiple POS systems may be associated with a common business (e.g., a franchise, a common business owner, etc.) with a common list of products and/or services. Accordingly, POS systems 408, 410 may be associated with a common business (e.g., common business 422) and may share a common set of products and/or services. In some implementations, POS systems 408, 410 may be identical.

As discussed in U.S. patent application Ser. No. 16/416,755, which is incorporated by reference in its entirety, a standardized hierarchy of components may be generated based upon, at least in part, the point-of-sales data received from each POS system. In this manner, distinctly categorized food and beverage products may be standardized into common components in a standardized hierarchy. In this manner, dashboard generation process 10 may generate analytical data based upon, at least in part, the point-of-sales data from the POS system of a client by defining the point-of-sales data in terms of the standardized hierarchy of components. As will be discussed in greater detail below and in some implementations, dashboard generation process 10 may generate a first dashboard based upon, at least in part, the analytical data generated using the standardized hierarchy of components and the point-of-sale data associated with the client.

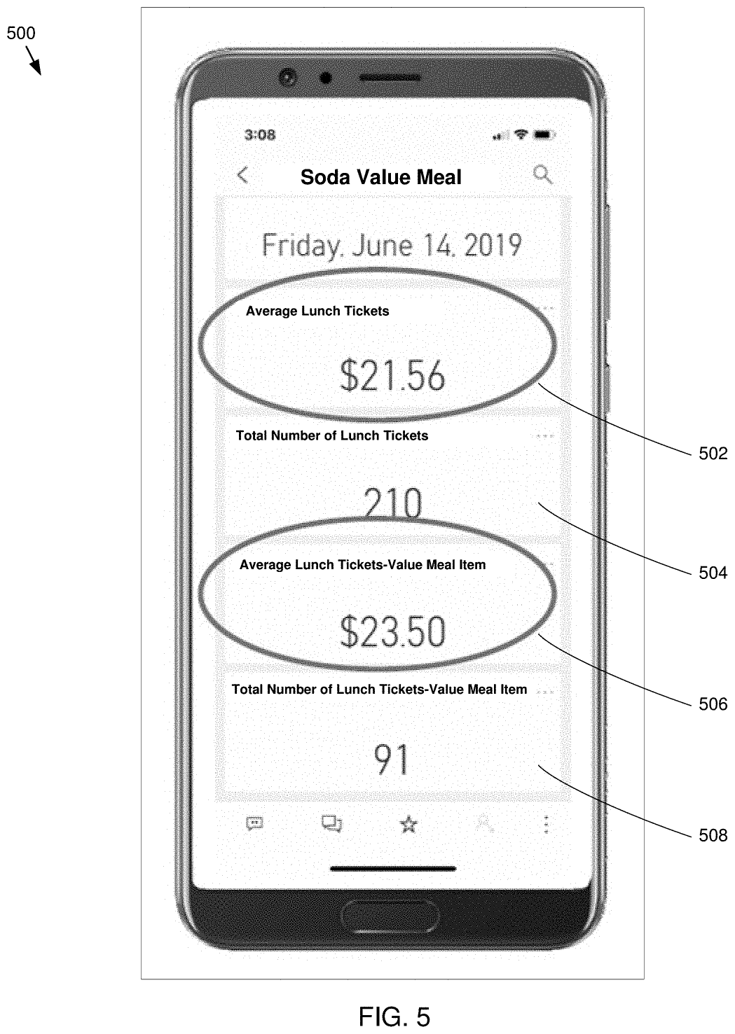

In some implementations, a first dashboard generated 204 by dashboard generation process 10 may include various analytical data. For example and as shown in FIG. 5, a first dashboard generated 204 by dashboard generation process 10 may include an appreciation of an average check amount transacted over the defined period of time. Consistent with the same, analytics of point-of-sale data associated with the client may quantify one or more promotions and a return on investment (ROI) consistent with the same. For example, a quantification of one or more promotions may appear as a comparison of an average cost for a e.g., lunch ticket relative to an average cost of a lunch ticket including a value-menu item. The quantification of the one or more promotions may also include a comparison of a total amount of lunch tickets sold, and specifically the total amount of lunch tickets sold for value-menu items. While an example has been described using “lunch tickets”, it will be appreciated that this is an example and that other tickets associated with other meals and/or inventory provided by a service provider affiliated with a respective service industry may be used within the scope of the present disclosure.

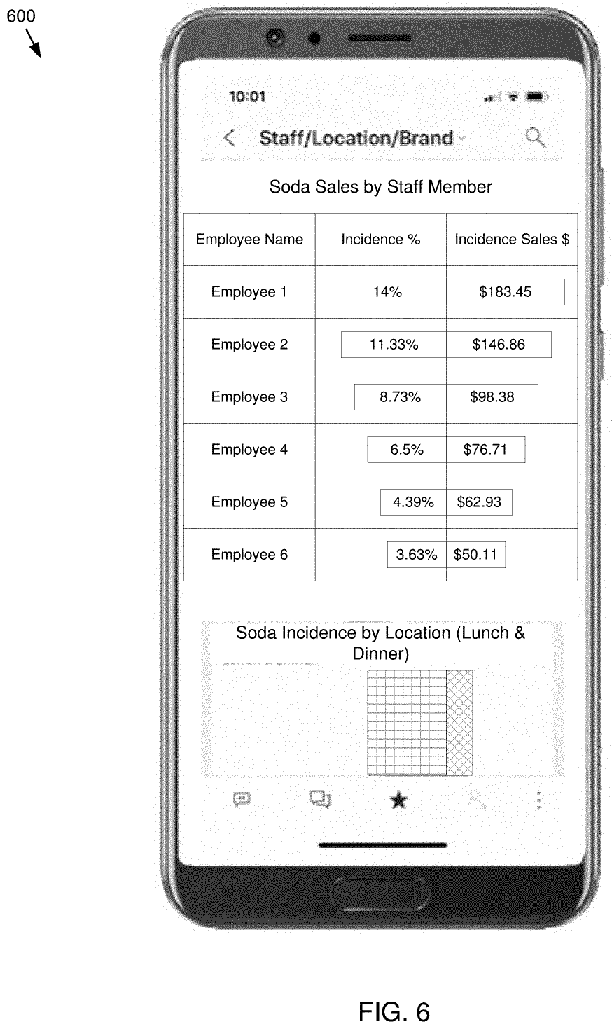

For example, and referring also to FIG. 6, a first dashboard may be generated with point-of-sales data with an appreciation of incidence sales (categorized by the rate at which a product or brand is sold, i.e., percentage of occurrence, and translation of such rate in dollar amount) transacted per staff member (e.g., server, employee, etc.) employed by the client, via one or more computation tools, to gauge a performance measure of each staff member with respect to a particular location relative to the client's business and over a defined period of time (e.g., time of day, per hour, per day, per month, per year, etc.). For example, suppose Restaurant A completed 100 transactions during lunch time. Of those 100 transactions, 83 transactions include a specific brand soda product on their respective transaction ticket. As such, the specific brand soda product maintains an incidence of 83% at lunchtime. The same measure may be applied for, e.g., a purchase of a branded or generally defined diet soda product, as well as for a purchase of any priced beverage (i.e., not including “free” water). For example, and referring again to FIG. 6, suppose Employee 1 has completed 40 transactions at lunch. If 6 of those transactions include the sale of liquor, beer, or wine (i.e., sale of alcohol), the sale of liquor, beer, or wine would report a 14% incidence. Consistent with the same, suppose for example purposes that Employee 1 maintains the highest performance measure of all staff members based upon incidence sales. A dashboard simulation may be automated to prospectively depict a measure of productivity and relative profit of the establishment, e.g., restaurant, had all remaining staff members performed similarly to Employee 1, or may provide an assessment of incidence sales as they compare between the present week and prior week when Employee 1 was on vacation. Using the example of FIG. 6, which discusses the comparison of incidence sales per staff member, dashboard generation process 10 may identify insights relative to the data points (i.e., data points that require monitoring in order to appropriately customize and/or change a dashboard) representative of incidence sales per staff member, and subsequently recommend a specific dashboard capable of measuring the same insights.

Additionally, in some implementations, a first dashboard generated 204 by dashboard generation process 10 may include an appreciation of total sales relative to food pairings (e.g., popular food and beverage pairings). Consistent with the same, the first dashboard may include incidence statistics. For example, incidence statistics may provide a calculated percentage of checks detailing a specific brand item sold regardless of the specific product or food pairing. However, it will be appreciated that other analytical data may be generated and provided to a client via the first dashboard (e.g., first dashboard 324). As will be described in more detail below, in some implementations, generating 204 a first dashboard may include implementing approved billing terms using a click connect approval process between the sales representative and the client. Consistent with the foregoing, suppose that a sales representative associated with a sponsor seeks to provide a client with a demonstration of a provider dashboard generating process. Using an administrative dashboard, a sales representative may import, maintain, and manage new customer information during a sales presentation, of which the new customer may approve such changes via the click connect approval process as discussed above.

While examples of types of analytical data that may be provided in a first dashboard have been provided, it will be appreciated that many other types of analytical data may be used within the scope of the present disclosure.

In some implementations, dashboard generation process 10 may utilize third party data in the generation of the first dashboard. For example and in some implementations, dashboard generation process 10 may receive and utilize third party data (e.g., weather data and relative normalization index over time) when generating the first dashboard. While an example with weather data has been provided, it will be appreciated that any kind of third party data may be utilize within the scope of the present disclosure.

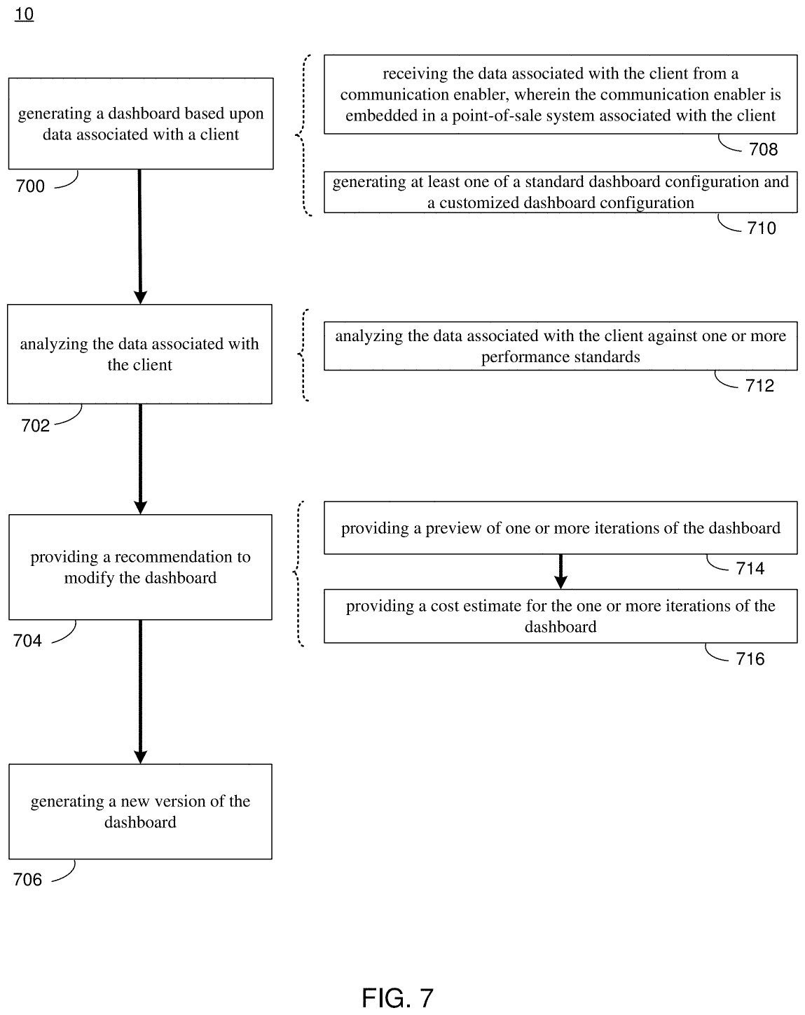

As discussed above and referring also at least to the example implementations of FIGS. 2-9, dashboard generation process 10 may generate 700 a dashboard based upon data associated with a client. The data associated with the client may be analyzed 702. A recommendation to modify the dashboard may be provided 704. A new version of the dashboard may be generated 706.

In some implementations and as discussed above, a dashboard may generally include a software module with one or more user interface portions for displaying analytical data generated from point-of-sale data received from the client. In some implementations, as a user accesses a dashboard and the analytical data provided by the analytics provider, a user may desire new analytical data and/or may spend more time accessing a certain portion of analytical data. Accordingly, dashboard generation process 10 may generate dashboards to meet a client's needs and/or to provide the client with new insights. Analytical data may generate include data that provides insights or helps a user understand their own data.

In some implementations, dashboard generation process 10 may generate 700 a dashboard based upon data associated with a client. Referring again to the example of FIG. 3 and as discussed above, dashboard generation process 10 may generate 700 a dashboard (e.g., first dashboard 324) based upon, at least in part, data associated with a client (e.g., client 306). In some implementations, an analytics provider database (e.g., analytics provider database 314) may include a library of dashboard configurations (e.g., standard dashboard configurations and/or customized dashboard configurations).

In some implementations, generating 700 the dashboard based upon the data associated with the client may include receiving 708 the data associated with the client from a communication enabler, wherein the communication enabler may be embedded in a point-of-sale system associated with the client. For example and referring again to the example of FIG. 3, the communication enabler (e.g., communication enabler 322) may be embedded or installed in a client network associated with a client, such that the communication enabler (e.g., communication enabler 322) may allow data to be conveyed from the client (e.g., client 306) to an analytics provider (e.g., analytics provider database 314). In some implementations, data may be conveyed to and from the provider from dashboard to dashboard, dashboard to a report, dashboard to an API provider, a series of API providers that make and respond to calls between computing devices, etc.

In some implementations, generating 700 the dashboard based upon the data associated with the client may include generating 710 at least one of a standard dashboard configuration and a customized dashboard configuration. In some implementations, a standard dashboard configuration may generally include a default dashboard configuration with one or more dashboard portions configured to provide one or more default analytical data representations and/or default client information. In some implementations and referring again to the example of FIG. 5, dashboard generation process 10 may provide a standard dashboard configuration with various dashboard portions. In the example of FIG. 5, dashboard generation process 10 may provide e.g., four dashboard portions for displaying e.g., four sets of analytical data associated with a client's point-of-sales data. For example, a first portion (e.g., dashboard portion 502) may include “average lunch tickets”; a second portion (e.g., dashboard portion 504) may include “total number of lunch tickets”; a third portion (e.g., dashboard portion 506) may include “average lunch tickets-value meal item”; and a fourth portion (e.g., dashboard portion 508) may include “total number of lunch-tickets-value meal item”. While four examples of dashboard portions have been described above, it will be appreciated that any default dashboard portions may be used within the scope of the present disclosure.

In some implementations, the dashboard portions of the dashboard may be configured to automatically change over time. For example and referring again to the example of FIG. 5, while the dashboard of FIG. 5 includes reference to “lunch” point-of-sales data, dashboard generation process 10 may automatically change or update the dashboard portions throughout a defined period of time. Suppose for example that a point-of-sale system defines “lunch” as point-of-sales data between e.g., 11 A.M. and 3 P.M. After 3 P.M., dashboard generation process 10 may change or update the dashboard portions with e.g., “dinner” point-of-sales data. Accordingly, it will be appreciated that dashboard generation process 10 may automatically change or update dashboard portions over time. Consistent with the same, as data accumulates over time, dashboards may be automatically generated according to e.g., the day of the week, week over week, month over month, quarter over quarter, year over year analysis dashboards, and may also provide a client with various plan comparisons. In some implementations, dashboard generation process 10 may automatically create dashboard portions as changes in organization occur. For example, suppose a regional manager looks at total sales as they compare from this year and last year, but may want to do so while keeping with same dashboard for the same stores. The regional manager may refer to a dashboard view having the same staff, or looking at total sales of the same products.

In some implementations, a customized dashboard configuration may generally include a dashboard configuration with one or more custom dashboard portions. For example, dashboard portions of customized dashboard configuration may be configured to include a client's logo, specific data fields within analytical data displays, particular nomenclature used by a client (e.g., “combo” v. “value meal”), etc. In this manner, a client may customize a dashboard configuration via dashboard generation process 10. While examples of customizable dashboard configurations have been provided, it will be appreciated that any modification to a standard dashboard configuration may constitute a customized dashboard configuration.

In some implementations, generating 710 at least one of the standard dashboard configuration and the customized dashboard configuration may be based upon, at least in part, a set of rules, which may automate the creation of the dashboard and minimize overall effort to create one or more versions of both the standard dashboard configuration and the customized dashboard configuration. For example, the set of rules may be based upon, at least in part, one or more of a logo library (i.e. approved brands of franchisees); a plurality of account standards from check lists; a linkage and integration with system and account administrative views; an aggregation of existing and historical account standards to determine content and priority order for check list entries; use of access control systems and the data to ensure that licensed text and logos are approved by owner for customers; etc. While several examples of rules that may be used to automate the generation of the dashboard have been provided, it will be appreciated that any number of rules may be defined for generating the dashboard.

In some implementations, dashboard generation process 10 may analyze 702 the data associated with the client. For example and in some implementations, dashboard generation process 10 may analyze 702 the data associated with the client in real time (e.g., as the point-of-sale data is provided to the analytical provider database and/or as the client interacts with the dashboard) based on a plurality of data metrics. In some implementations and as will be discussed in greater detail below, clients (e.g., client 306) may not be aware that certain anomalies in their business performance indicate expanded use of an existing view or creation of a new view to improve business performance. In this manner, dashboard generation process 10 may analyze 702 client data against known restaurant business problems and provide 704 recommendations to the client for existing or new dashboard configurations that may highlight opportunities for the client to address the known business problems.

In some implementations, analyzing 702 the data associated with the client may include analyzing 712 the data associated with the client against one or more performance standards. For example, dashboard generation process 10 may analyze client performance (e.g., point-of-sale data associated with a client) against client-defined, analytics provider-defined, industry, segment, franchise, regional, and/or other performance standards and identify at the client, location, product, and/or client segment level performance variations. A performance standard may generally include any metric used to evaluate the client. For example, a performance standard may include a statistical relationship of the client with other businesses (e.g., average, maximum, minimum, etc.) based on the industry, segment, franchise, region, etc. of the client. For example, suppose a performance standard associated with a franchise indicates that e.g., out of every 100 transactions, 55 of those should be value-meal items. A prospective client who may own the same kind of franchise may refer to this standard. In some implementations, the performance standard may be defined and received from a third-party. For example, third-party performance standards may be used to evaluate the client.

For example, analytics performed on the point-of-sale data may reveal that client 306's establishment is the most profitable food and beverage business on e.g., Tuesday evenings in the region. In another example, analytics performed on the point-of-sale data may reveal that client 306's establishment is selling e.g., a particular food product at the highest price in town. Accordingly, performance standards may define a statistical relationship between the client and other food and beverage businesses.

In some implementations, dashboard generation process 10 may provide 704 a recommendation to modify the dashboard. For example and as discussed above, when analyzing 702 the point-of-sales data associated with a client, dashboard generation process 10 may identify one or more problems, issues with, and/or opportunities for the client based upon, at least in part, the point-of-sales data of other franchisees, competitors, other local food and beverage businesses, etc. and the point-of-sales data associated with the client. For example and as discussed above, suppose dashboard generation process 10 identifies that client 306's e.g., amount of beverage cross selling during lunch on Wednesdays is significantly lower than the rest of the week. Referring also to the example of FIG. 6 and in some implementations, dashboard generation process 10 may recommend a dashboard to model the number of incidence sales of a particular beverage per staff member. In this example, dashboard generation process 10 may correlate the lower number of cross selling of a beverage product with one or more staff members based upon, at least in part, the analytical data shown in the example of FIG. 6. While an example of beverage product cross-selling has been provided, it will be appreciated that any dashboard or dashboard portion may be recommended 704 to a client within the scope of the present disclosure.

In some implementations, providing 704 the recommendation to modify the dashboard may include providing 714 a preview of one or more iterations of the dashboard. For example, when providing 704 a recommendation to modify the dashboard, dashboard generation process 10 may provide 714 or generate a preview of one or more iterations or dashboard configurations of the dashboard for a user to test for a predefined period of time with sample data and/or point-of-sale data associated with the client. For example, suppose a user (e.g., user 304) is provided 704 with a recommendation for a dashboard describing e.g., the number of soft drinks sold during dinner at a particular food and beverage business. In this example, dashboard generation process 10 may generate a preview of the recommended dashboard with simulated analytical data or actual analytical data generated based upon, at least in part, the client's point-of-sales data.

In some implementations, dashboard generation process 10 may generate 706 a new version of the dashboard. In some implementations, dashboard generation process 10 may receive an approval or selection of a recommended dashboard or dashboard configuration from a user. In response to the approval or selection of the recommended dashboard, dashboard generation process 10 may generate 706 the new version of the dashboard including the recommended dashboard portions. In some implementations, generating 706 the new version of the dashboard may include storing a prior version of the dashboard in a library of the user application, where the prior version can be retrieved and reinstituted into a new dashboard at a later date. For example, suppose that user 304 leaves her current position with client 306 and begins new employment with another client. In this example, assume that user 304 becomes the new manager of the other client. In this example, because dashboard generation process 10 may maintain dashboards for each client, dashboard generation process 10 may generate a new version of a previous dashboard used by user 304 at client 306 with the new point-of-sale data.

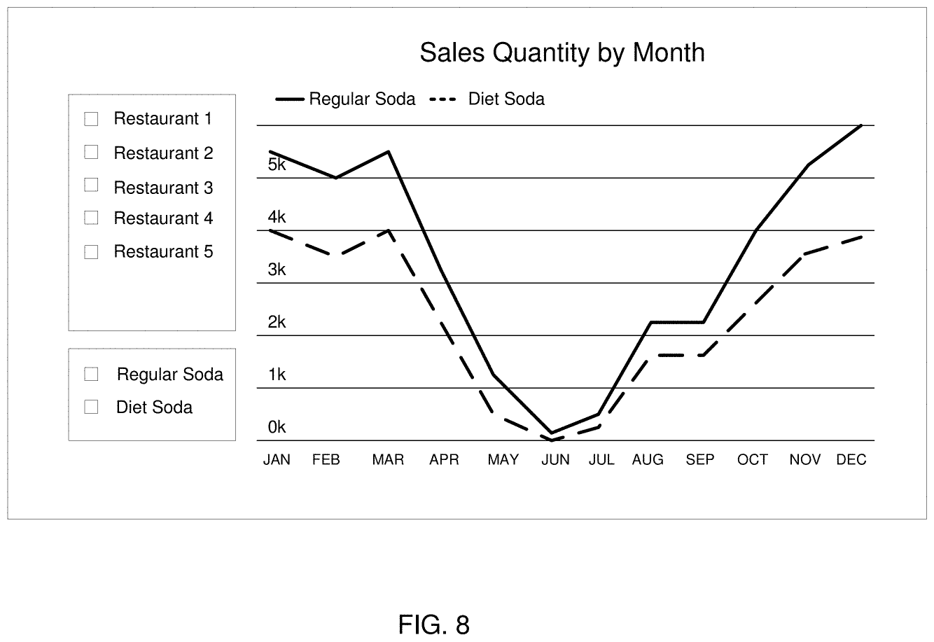

In some implementations, providing 704 the recommendation to modify the dashboard may include providing 716 a cost estimate for the one or more iterations of the dashboard. For example, suppose client 306 determines that they need special dashboard views that are not available in the analytics provider database/library. Referring also to the example of FIG. 8 and in some implementations, suppose user 304 desires to obtain analytical data specifying e.g., sales quantities of a diet soda and a regular soda per month. Suppose that this dashboard is not predefined or already stored in analytics provider database 314. In some implementations, dashboard generation process 10 may assist a user in developing a dashboard or dashboard portion. In some implementations, dashboard generation process 10 may provide user 304 with access to a design version of a specific existing dashboard or view that allows changing the order, detail, and computations of various fields. For example, dashboard generation process 10 may prompt a user to select particular customers, products, categories, etc. for the new dashboard.

In some embodiments, dashboard generation process 10 may provide a computation estimation tool that measures data and computer usage for each new dashboard and links to a pricing table for the new view. For example, dashboard generation process 10 may determine a computing requirement for providing the new dashboard to client 306. For example, generating specific analytical data (e.g., via analytics provider database 314) may require a certain amount of computing resources. For example, there are some computations that an analytics provider may not want customers to do, i.e., adding up all of the servers who work at major restaurant chain across the nation and do some statistical variation across the entire server database which would require a significant number of computing resources. In some implementations, dashboard generation process 10 may be configure to implement a restriction basis for a particular analytic operation on the basis of computation complexity and cost, group preservation and anonymity and de-identified data (i.e., if there is not a large enough sample and the computation would expose the other people enabled in a particular territory and their point of sales). In some implementations, the restriction basis may prohibit the generation of the new dashboard, may limit the granularity of the analytical data in the new dashboard, etc.

In some implementations, dashboard generation process 10 may generate a test version of the new dashboard and may provide a user with a cost estimate for the dashboard. For example and as discussed above, as different dashboards may require different amounts of computing resources, dashboard generation process 10 may provide a user with a cost estimate for generating a new dashboard. In some implementations, dashboard generation process 10 may provide a user with a cost estimate based upon, at least in part, an amount of data to be analyzed for the new dashboard and/or the number of users to access the new dashboard. For example, suppose user 304 wants to generate a dashboard for ten of its retail locations that she and three other employees can access. Dashboard generation process 10 may provide user 304 with a cost estimate for generating the new dashboard for the ten retail locations accessible by four total users. While an example of a particular number of stores and a particular number of users has been provided, it will be appreciated that any amount of data (e.g., number of transactions, units of time, number of employees, etc.) may be used within the scope of the present disclosure.

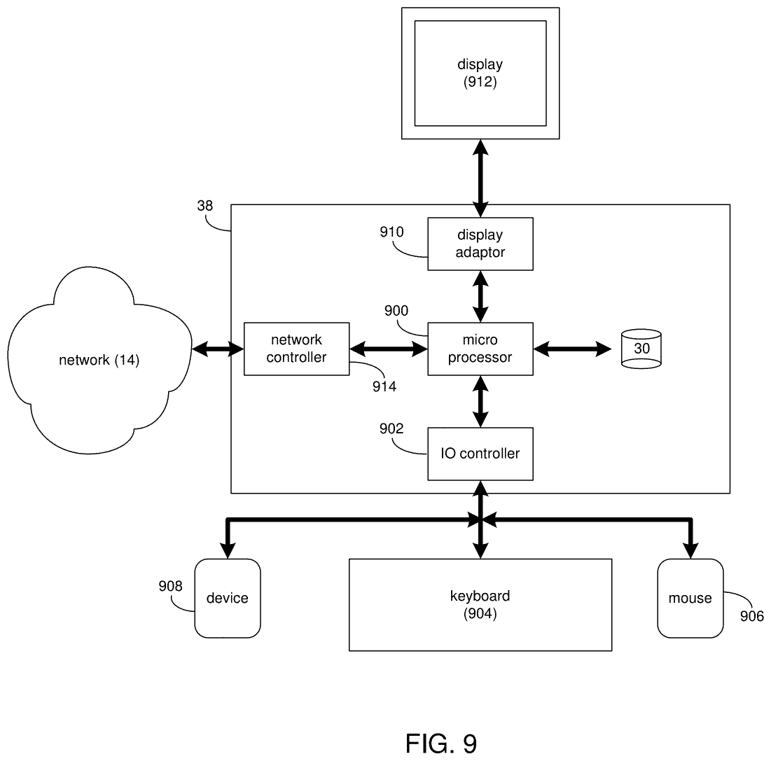

Referring also to the example implementation of FIG. 9, there is shown a diagrammatic view of client electronic device 38. While client electronic device 38 is shown in this figure, this is for example purposes only and is not intended to be a limitation of this disclosure, as other configurations are possible. Additionally, any computing device capable of executing, in whole or in part, dashboard generation process 10 may be substituted for client electronic device 38 (in whole or in part) within FIG. 9, examples of which may include but are not limited to computer 12 and/or one or more of client electronic devices 40, 42, 44.

In some implementations, client electronic device 38 may include a processor (e.g., microprocessor 900) configured to, e.g., process data and execute the above-noted code/instruction sets and subroutines. Microprocessor 900 may be coupled via a storage adaptor to the above-noted storage device(s) (e.g., storage device 30). An I/O controller (e.g., I/O controller 902) may be configured to couple microprocessor 900 with various devices (e.g., via wired or wireless connection), such as keyboard 904, pointing/selecting device 906 (e.g., touchpad, touchscreen, mouse, etc.), USB ports, printer ports, and/or other device 908. A display adaptor (e.g., display adaptor 910) may be configured to couple display 912 (e.g., touchscreen monitor(s), plasma, CRT, or LCD monitor(s), etc.) with microprocessor 900, while network controller/adaptor 914 (e.g., an Ethernet adaptor) may be configured to couple microprocessor 900 to the above-noted network 14 (e.g., the Internet or a local area network).

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
preloading, on a first computing device, data associated with a client;
executing, via the first computing device, an authorization process between the first computing device and a second computing device; and
generating a first dashboard on the second computing device, the first dashboard including the data associated with the client.

2. The computer-implemented method according to claim 1, further comprising:
establishing a connection between the second computing device and a communication enabler.

3. The computer-implemented method of claim 1 wherein the data associated with the client includes, at least in part, point-of-sale data.

4. The computer-implemented method of claim 1 wherein preloading the data associated with the client includes:
generating a sample dashboard, wherein the sample dashboard includes at least a portion of the data associated with the client.

5. The computer-implemented method according to claim 1 wherein executing the authorization process between the first computing device and the second computing device includes:
generating an invitation, via an authorization window, on the first computing device.

6. The computer-implemented method according to claim 5 wherein executing the authorization process between the first computing device and the second computing device further includes:
sending the invitation from the first computing device to the second computing device.

7. The computer-implemented method according to claim 6 wherein executing the authorization process between the first computing device and the second computing device further includes:
verifying, at the second computing device, the data associated with the client.

8. A computer program product comprising a non-transitory computer readable medium having a plurality of instructions stored thereon, which, when executed by a processor, cause the processor to perform operations including:
preloading, on a first computing device, data associated with a client;
executing, via the first computing device, an authorization process between the first computing device and a second computing device; and
generating a first dashboard on the second computing device, the first dashboard including the data associated with the client.

9. The computer program product according to claim 8, further comprising:
establishing a connection between the second computing device and a communication enabler.

10. The computer program product according to claim 8, wherein the data associated with the client includes, at least in part, point-of-sale data.

11. The computer program product according to claim 8 wherein preloading the data associated with the client includes:
generating a sample dashboard, wherein the sample dashboard includes at least a portion of the data associated with the client.

12. The computer program product according to claim 11 wherein executing the authorization process between the first computing device and the second computing device includes:
generating an invitation, via an authorization window, on the first computing device.

13. The computer program product according to claim 12 wherein executing the authorization process between the first computing device and the second computing device further includes:
sending the invitation from the first computing device to the second computing device.

14. The computer program product according to claim 13 wherein executing the authorization process between the first computing device and the second computing device further includes:
verifying, at the second computing device, the data associated with the client.

15. A computing system including one or more processors and one or more memories configured to perform operations comprising:
preloading, on a first computing device, data associated with a client;
executing, via the first computing device, an authorization process between the first computing device and a second computing device;
establishing a connection between the second computing device and a communication enabler; and
generating a first dashboard on the second computing device, the first dashboard including the data associated with the client.

16. The computing system according to claim 15 wherein the data associated with the client includes, at least in part, point-of-sale data.

17. The computing system according to claim 15 wherein preloading the data associated with the client includes:
generating a sample dashboard, wherein the sample dashboard includes at least a portion of the data associated with the client.

18. The computing system according to claim 15 wherein executing the authorization process between the first computing device and the second computing device includes:
generating an invitation, via an authorization window, on the first computing device.

19. The computing system according to claim 18 wherein executing the authorization process between the first computing device and the second computing device further includes:
sending the invitation from the first computing device to the second computing device.

20. The computing system according to claim 19 wherein executing the authorization process between the first computing device and the second computing device further includes:
verifying, at the second computing device, the data associated with the client.
